(19) United States
(12) Patent Application Publication
(10) Pub. No.: US 2007/0086937 A1
(43) Pub. Date: Apr. 19, 2007

(54) Use of a silicon carbide-based ceramic material in aggressive environments

(75) Inventors: Charlotte Pham, Saverne (FR); Cuong Pham-Huu, Strasbourg (FR); Marc-Jacques Ledoux, Strasbourg (FR); Patricks Nguyen, Strasbourg (FR)

Correspondence Address: BAKER DONELSON BEARMAN CALDWELL & BERKOWITZ, PC, 555 11TH STREET, NW, 6TH FLOOR, WASHINGTON, DC, 20004, US

(73) Assignees: Universite Louis Pasteur de Strasbourg, Strasbourg (FR); SICAT, Paris (FR); Centre National de la Recherche Scientifique, Paris (FR)

(21) Appl. No.: 10/553,654

(22) PCT Filed: Apr. 15, 2004
(86) PCT No.: PCT/FR04/00929

§ 371 Date: Aug. 4, 2006

(30) Foreign Application Priority Data
Apr. 16, 2003 (FR) 03/04749

(51) Int. Cl. C01B 31/36

(52) U.S. Cl. 423/345

(57) ABSTRACT

A SiC-based composite material capable of use as an inner coating for an aluminium smelting furnace or as an inner coating for a fused salt electrolytic cell, wherein said composite material has been prepared from a precursor mixture comprising at least one β-SiC precursor and at least one carbonated resin, and wherein said composite material contains inclusions, and wherein at least one part thereof comprises α-SiC, in a β-SiC matrix.

### FIELD OF THE INVENTION

The present invention relates to ceramic materials for use in aggressive environments, as found particularly in chemical and electro-metallurgical engineering, and more specifically the refractory bricks used in smelting furnaces or electrolytic cells.

### STATE OF THE RELATED ART

Liquid metals and fused salts are among the most aggressive chemical agents known. As numerous metallurgical and electro-metallurgical industrial processes involve the melting of metals and/or salts, there is a need for refractory materials which can withstand such an environment. Equipment for molten metals or fused salts, typically smelting furnaces or fused salt electrolytic cells, require an inner coating consisting of large quantities of refractory bricks or panels and the replacement of said refractory elements, also referred to as relining, immobilises the equipment for some time. Therefore, a material with an improved service life in such an environment may result in at least three advantages: 1) lower consumption of refractory material, 2) lower contamination of the molten environment by said refractory environment, and 3) reduced equipment immobilisation time (or downtime) for maintenance.

In addition, these materials must withstand thermal and mechanical shocks liable to occur during their use in such equipment.

Silicon carbide of a structure, which crystallises in a hexagonal system, bound with other inorganic stabilisers, is one of the materials most frequently used in various industries such as coating ceramics due to its exceptional mechanical and thermal properties, and due to its high chemical resistances to corrosive agents, essentially alkalines. Refractory bricks made of α-SiC for use in fused salt electrolytic cells are frequently required to have an open porosity which is as low as possible, so as to minimise the penetration of the corrosive environment inside the refractory material (see patent U.S. Pat. No. 5,560,809 (Saint-Gobain)).

This material can be obtained in various macroscopic forms such as a brick, cylinder or monolith, selected according to the target application. The shaping of silicon carbide generally involves, on one hand, silicon carbon-based powders or aggregates, and, on the other, inorganic binders. For example, to produce refractory bricks for electro-metallurgical electrolytic cells, either aluminium oxide in solid solution in Si₃N₄ corresponding to the formula Si₃₋ₓAlₓOₓN₄₋ₓ, silicon oxynitride Si₂ON₂, or silicon nitride Si₃N₄ is used as a binder. The shaping is then carried out using a process enabling intimate binding of the compounds contained in the final composite, such as hot sintering.

This composite material has a beneficial combination of physical and chemical properties, such as a high mechanical resistance (particularly rupture strength and hardness), a high thermal resistance (particularly a low expansion coefficient and a high thermal stability), and a high oxidation resistance, whereby the material can be used in the open air at temperatures in excess of 1000° C. This material can also withstand weakly alkaline solutions.

It also suffers from some drawbacks. Its relatively high cost is associated with the use of high temperatures during synthesis. With respect to its resistance in corrosive environments, for some types of binders, weakening with respect to some highly corrosive chemical agents initially present in the operating environment, or formed in the operating environment, is observed. In fact, it is observed that, in some applications of this material, the presence of corrosive products, such as acids or fluorinated compounds or strongly basic products, induces a progressive destruction of the compounds contained in the binder. This eventually leads to the total dissolution of said binder, and, as a result, the destruction of the macroscopic shape of the material. In this way, the element made of α-SiC, e.g. a refractory brick, is converted into powder and/or aggregates, with the loss of its shape and its initial mechanical characteristics.

Two methods have been studied in the prior art to protect SiC-based composites against corrosion: coating the SiC-based ceramic elements with a protective layer with a higher corrosion resistance, and the use of binders with a higher corrosion resistance.

The first method is represented by the patent application FR 2 806 406 A1 (French Atomic Energy Commission). It describes a method to deposit a layer on the surface of SiC-based composites, such as non-pressurised sintered SiC, Si-infiltrated SiC, porous recrystallised SiC, in order to protect them against corrosion and increase their chemical resistance for use at a temperature of up to 1600° C. The method implemented consists of preparing a mixture by dispersing in a liquid binder the different constituents of the deposition layer, i.e. metal or silicide, Si, SiC and/or carbon, and then coating the surface of the element to be protected with said mixture. The whole is then heated to a temperature between 1200 and 1850° C. The surface of the SiC element to be treated is coated by melting said mixture onto the surface of said element to be treated. The deposition formed in this way has an average thickness ranging from 1 to 50 μm. The nature and resistance of the deposition varies according to the nature of said metal and the composition of the layer applied. Nevertheless, the examples given only relate to compositions of the deposition layer and the observation of the latter with an electron microscope without providing more information on the increased resistance of said composite with respect to oxidation or aggressive environments which represent the intended end purpose.

A specific drawback of this method is the possible appearance of microcracking between the protective layer and the composite during the production or use of elements coated in this way, due to differences between the heat expansion coefficients.

The second method is based on the idea that the chemical nature of the binders used in SiC-based ceramic materials determines their resistance to corrosion by aggressive chemical agents such as fluorinated derivatives or concentrated acids or alkalis. According to the state of the art, sinterable oxide, nitride or oxynitride-based binders are particularly used.

In the methods according to the prior art, α structure silicon carbide in powder form obtained directly from conventional carboreduction syntheses according to reaction (1) is used:
SiO₂+3C→α-SiC (or β-SiC)+2CO (1)

The reaction (1) can be broken down into two basic reactions which are as follows:
SiO₂+C→SiO+CO (2)
SiO₂+2C→SiO+CO (3)

However, SiO escapes very rapidly from the reaction environment before the reaction (3) is complete and, for this reason, induces a non-negligible loss of the initial silicon, leaving a large quantity of non-reacted carbon in the final material. The patent U.S. Pat. No. 4,368,181 (Hiroshige Suzuki) proposes to improve this method by reacting fine particles consisting of carbon, i.e. mean diameter of the order of 60 μm, and silica, i.e. mean diameter of the order of 150 μm, in a device enabling continuous recycling so as to reduce silicon losses induced by SiO losses and increase the SiC yield. However, the SiC formed using this method is always in the form of very fine powder and requires another pre-forming step with binders before use. These binders are liable to be corroded by strongly acidic or basic solutions resulting in the destruction of the macroscopic structure of the material.

In addition, from the patent EP 511 919, a production method of porous SiC catalyst substrates in the form of rods or extruded granules from a mixture of silicon powder and organic resin by means of polymerisation followed by carburisation is known.

The patent applications or patents U.S. Pat. No. 5,474,587 (Forschungszentrum Julich GmbH), US 2002/011683 A1 (Corning Inc), EP 0 356 800 A (Shinetsu Chemical Co), U.S. Pat. No. 4,455,385 (General Electric Co), U.S. Pat. No. 4,562,040 (Sumitomo), U.S. Pat. No. 4,514,346 (Kernforschungsanlage Jüilich), U.S. Pat. No. 6,245,424 (Saint-Gobain Industrial Ceramics) and U.S. Pat. No. 3,205,043 (The Carborundum Company) also illustrate the production and use of such SiC-based materials.

Problem Statement

The present invention attempts to overcome these drawbacks of the methods according to the prior art. It aims to propose inner coating products for industrial furnaces and electrolytic cells made of silicon carbide-based ceramic material, which offer an improved resistance to attacks from corrosive environments, particularly fluorinated environments, concentrated acids and alkaline environments, while retaining the known exceptional physical properties of SiC.

### DESCRIPTION OF THE FIGURES

FIG. 1 shows scanning electron microscope images of the composite after carburisation in a dynamic vacuum at 1300° C. for 2 hours. The wetting of the α-SiC grains with the β-SiC matrix is visible on the microscope image shown in FIG. 1B.

FIG. 2 shows optical images of a composite consisting of α-SiC-based aggregates with Al₂O₃— and Si₃N₄-based binders before (A) and after (B) quenching in a 40% by volume HF solution for 10 hours. The dissolution of the binders by HF induced the complete destruction of the macroscopic structure of the initial material.

The images (C, D) correspond to a composite consisting of α-SiC aggregates in a β-SiC matrix having undergone the same treatment as that in images (A) and (B).

The high resistance of this material with respect to attacks by highly corrosive solutions is observed.

### SUBJECT OF THE INVENTION

The present invention relates to the use of an SiC-based composite material as an inner coating for an aluminium smelting furnace or as an inner coating for a fused salt electrolytic cell, characterised in that said composite material contains inclusions, wherein at least one part consists of α-SiC, in a β-SiC matrix.

### DESCRIPTION OF THE INVENTION

The problem is solved according to the present invention by replacing the oxide-based binders used in the known methods by a matrix consisting of β structure silicon carbide (which crystallises in a centred face cubic system) and by adding inclusions.

Such a material may be advantageously produced using a method comprising

(a) the preparation of a so-called “precursor mixture” comprising at least one β-SiC precursor, which may particularly come in the form of powder, grains, or fibres of various sizes, with at least one carbonated resin, preferentially of the duroplastic type,

(b) the shaping of said precursor mixture, particularly into panels or bricks;

(c) the polymerisation of the resin,

(d) heat treatment at a temperature between 1100 and 1500° C. to eliminate the organic constituents from the resin and form the final element.

The term “β-SiC precursor” refers to a compound which forms, under the heat treatment conditions (step (d)), with the constituents of the β-SiC resin. Silicon, more specifically in powder form, is preferred as the β-SiC precursor. This silicon powder may be a commercially available powder, of known grain size and purity. For homogeneity reasons, the grain size of the silicon powder is preferably between 0.1 and 20 μm, preferentially between 2 and 20 μm, and more specifically between 5 and 20 μm.

The term “carbonated resin” refers to any resin containing carbon atoms. It is neither necessary nor useful for it to contain silicon atoms. Advantageously, the silicon is provided only by the β-SiC precursor. The resin is advantageously selected from duroplastic resins containing carbon, particularly from phenolic, acrylic or furfurylic resins. A phenolic type resin is preferred.

In the precursor mixture, the respective quantities of resin and β-SiC precursor are adjusted so as to convert the β-SiC precursor quantitatively into β-SiC. To this end, the quantity of carbon contained in the resin is calculated. Part of the carbon may also be provided by directly adding a carbon powder into the mixture of carbonate resin and β-SiC precursor. This carbon powder may be a commercially available powder, e.g. carbon black, of known grain size and purity. For mixture homogeneity reasons, a grain size of less than 50 μm is preferred. The choice of the composition of the mixture is the result of a compromise between the viscosity, the cost of the raw materials and the desired final porosity. To ensure the complete conversion of the β-SiC precursor into β-SiC and thus make it possible to obtain a final material free from Si not used in the SiC structure, a slight excess of carbon is preferred in the precursor mixture. This excess carbon may then be burned in air. However, the excess must not be too high so as not to generate excessively high porosity within the material after the combustion of the residual carbon thus inducing weakening in the mechanical resistance of the final composite. A second infiltration of the composite synthesised in this way with the resin/Si mixture may be carried out, so as to reduce the porosity in the heart of the composite. This is useful for some applications which absolutely require minimisation of the porosity.

The precursor mixture may be shaped using any known method such as moulding, pressing, extrusion to obtain three-dimensional shapes such as bricks, panels or tiles. The selected method will be adapted to the viscosity of the precursor mixture, in turn dependent on the viscosity of the resin and the composition of the precursor mixture. For example, it is possible to obtain 1 mm thick panels one to several decimetres long and wide. It is also possible to produce bricks of a few centimetres to a few decimetres or more in size. It is also possible to obtain elements of more complex shapes, particularly by means of moulding.

Said precursor mixture is then heated in air at a temperature between 100° C. and 300° C., preferentially between 150° C. and 300° C., more preferentially between 150° C. and 250° C., and even more preferentially between 150° C. and 210° C. The duration of this treatment, during which the polymerisation of the resin and the hardening of the element are performed, is typically between 0.5 hours and 10 hours at the temperature stage, preferentially between 1 hr and 5 hrs, and more preferentially between 2 and 3 hours. During this step, the material releases volatile organic compounds which create a variable residual porosity as a function of the carbon content present in the composition of the precursor mixture and the conditions applied during polymerisation. It is preferable to minimise this porosity, particularly for the production of thick panels (typically at least 2 mm thick) and bricks. This obtains an intermediate element which has a specific mechanical resistance and, for this reason, is easy to handle.

Said intermediate element obtained in this way is subjected to heating in an inert atmosphere (e.g. helium or argon) or in a dynamic vacuum between 1100° C. and 1500° C. for a time ranging from 1 to 10 hours, preferentially between 1 and 5 hours and more specifically between 1 and 3 hours in order to carry out the carbonisation of the resin followed by the carburisation reaction of the matrix. The optimal temperature range is preferentially between 1200° C. and 1500° C., more specifically between 1250° C. and 1450° C. The most preferred range is between 1250° C. and 1400° C. The SiC formed from the carbon obtained from the resin and the β-SiC precursor is β-SiC.

When the carburisation treatment is performed in inert gas, the presence of oxygen traces is preferable, particularly when the resin comprises excess carbon. In this case, the carburisation may be carried out for example in an atmosphere containing traces of oxygen. In some cases, oxygen obtained from commercially available argon impurities may suffice. If the product after carburisation has a high residual carbon content, this may be easily removed by heating the elements in air at a temperature between 600° C. and 900° C., preferentially between 700° C. and 825° C., for a time advantageously between 10 minutes and 5 hours.

The applicant noted that the polymerisation rate influences the residual porosity in the final material, as excessively rapid polymerisation favours gas bubble formation. However, the presence of gas bubbles in the resin may favour the formation of microcracking in the ceramic composite, liable to weaken the material element during its use. This problem may particularly occur for the production of panels at least 1 mm thick, and bricks. Therefore, it is useful to carry out polymerisation relatively slowly, i.e. at a moderate temperature.

For the first infiltration step, the preferred method involves a carbonated resin, but does not require the use of a silicon-based organic resin, such as polycarboxysilane or polymethylsilane, which are used in known production methods of ceramics incorporating SiC fibres; see EP 1 063 210 A1 (Ishikawajima-Harima Heavy Industries, Ltd.); these silicon-based organic resins are relatively expensive and a significant loss of carbon after pyrolysis is observed.

The method described above is used to produce β-SiC-based refractory bricks or panels without inclusions. If no inclusions are added (e.g. in α-SiC form), said refractory bricks or panels have a density typically of the order of 1.5 g/cm³. This value is too low for some uses in corrosive environments, particularly in fluorinated environments.

In an advantageous embodiment, panels at least 1 mm thick, preferentially at least 3 mm thick, and more preferentially at least 5 mm thick, are produced. The smallest cross-section of said panels is advantageously at least 15 mm², and preferentially at least 50 mm², with a length or width over thickness ratio of at least 10 and preferentially at least 15. In another advantageous embodiment, bricks are produced. The smallest size of said bricks is advantageously at least 10 mm, and preferentially at least 50 mm or even 100 mm. The smallest cross-section of said bricks is advantageously at least 20 cm², preferentially at least 75 cm² and more advantageously at least 150 cm², with a length or width over thickness ratio of at least 3.

In both cases, it is necessary to limit the excess carbon and polymerise slowly to prevent the formation of large bubbles liable to weaken the material during its carburisation. For the use of the material as an inner coating of an industrial furnace, the material is prepared particularly in the form of panels or bricks, which may have the shape of a parallelepiped or any other suitable shape.

The applicant has observed that, for the use of the material in industrial furnaces or electrolytic cells, it is particularly advantageous to add to the precursor mixture inclusions wherein at least one part consists of α-SiC. In this case, step (a) described above is replaced by step (aa):

(aa) the preparation of a precursor mixture comprising inclusions, wherein at least one part consists of α-SiC, and a β-SiC precursor, which may come in the form of powder, grains, or fibres or inclusions of various sizes, with a carbonated resin, preferentially of the duroplastic type.

Typically, α-SiC of a variable grain size ranging from 0.1 to several millimetres is used for the inclusions. This alpha form silicon carbide may consist of any of the silicon carbides known to date. The inclusions are added to the precursor mixture at a proportion of at least 80% (by weight with respect to the total mass of the precursor mixture). Below 80%, the density of the finished element is too low, its open porosity is too high and the unfired element (formed element before firing) is too soft. Over 95%, the β-SiC binder can no longer wet the inclusions completely, which results in insufficient cohesion of the finished element. A fraction of approximately 90% inclusions is suitable for most applications in fluorinated corrosive environments.

Part of the α-SiC can be replaced by alumina, silica, TiN, Si₃N₄ or other inorganic solids which do not decompose and do not sublimate at the final composite synthesis temperatures. Advantageously, at least 50% and preferentially at least 70% by weight of the inclusions consist of α-SiC. According to the applicant's observations, for the use of the material as an inner coating for aluminium electrolytic cells or as an inner coating for an aluminium smelting furnace, the substitution of α-SiC by other inorganic inclusions does not provide a significant technical advantage.

The solid forming the inclusions is not restricted to a specific macroscopic form but can be used in different forms such as powders, grains, fibres. For example, to improve the mechanical properties of the final composite, α-SiC-based fibres are preferred as inclusions. These fibres may have a length in excess of 100 μm.

These inclusions, wherein at least part must consist of α-SiC, are mixed with a carbonated resin, preferentially of the duroplastic type, containing a given quantity of a β-SiC precursor, preferentially in the form of powder of a grain size ranging from 0.1 to several micrometres.

This obtains a α-SiC/β-SiC type composite material, comprising α-SiC particles in a β-SiC matrix, which does not need to contain other binders or additives.

A second infiltration treatment may be performed according to the same procedure described: quenching of said material in a mould containing resin, polymerisation and finally, carburisation treatment. Said resin must contain a sufficient quantity of β-SiC precursor, e.g. in silicon powder form. This second treatment makes it possible to improve the mechanical resistance and/or eliminate the problems inherent to the presence of an undesirable porosity, an improved resistance to attacks from corrosive environments, particularly fluorinated environments, concentrated acids or alkaline environments.

The heat treatment is also simplified as the composite can be formed indifferently in a dynamic vacuum or in an inert atmosphere, i.e. argon, helium, without requiring precise monitoring of the purity of said atmosphere, i.e. trace of oxygen or water vapour present as impurities in the gas used. In addition, the carburisation reaction is performed by means of nucleation within the carbon/silicon matrix itself and, for this reason, is completely independent of the size of the composite to be produced.

In a preferred alternative embodiment of the method, carbon and silicon are mixed intimately as follows: silicon powder (average grain size of approximately 10 μm) is mixed with a phenolic resin which, after polymerisation, provides the source of carbon required for the β-SiC formation reaction. The inclusions are then mixed with the resin and the whole is cast in a mould in the shape of the desired final composite. After polymerisation, the solid formed is transferred into a furnace used to conduct the final carburisation of the matrix. During the temperature rise, the structural or trapped oxygen in the matrix reacts with silicon and carbon to form SiO (equation (4)) and CO (equation (5)) within the solid matrix itself. Carburisation is then performed by means of a reaction between SiO and carbon (6) or CO with Si (7) according to the following equations:
2Si+O₂→2SiO (4)
2C+O₂→2 CO (5)
SiO+2C→SiC+CO (6)
2CO+2Si→2SiC+O₂ (7)

The fact that all the constituents are mixed intimately increases the final SiC yield considerably with very low silicon losses in the gas phase. The synthesis method also makes it possible to produce SiC with a predefined macroscopic shape and not in the form of a fine powder as was the case with the results of the prior art.

The method described above makes it possible to produce materials or composites with a β-SiC-based matrix that can contain inclusions based on silicon carbide or other materials resistant to uses in aggressive, strongly acidic or basic environments, or under high temperature stress.

The SiC-based composite material, which contains, in a β-SiC matrix, inclusions wherein at least part consists of α-SiC, has numerous advantages:

(i) It can be produced using the method described above with a relatively low cost price compared to other methods, in view of raw material costs (resin providing the source of carbon, silicon powder) and due to non-negligibie energy savings, as the method involves relatively low temperatures, i.e. ≦1400° C. The limited number of raw materials also allows a substantial cost reduction.

(ii) The shaping of the mixture may be performed preferentially before polymerisation by means of extrusion, moulding or pressing. It is easy given the nature of the starting material, i.e. a viscous resin-based matrix, silicon powder and inclusions in the form of dispersed α-SiC powder and/or grains. This makes it possible to pre-shape the material in relatively complex shapes. Alternatively, it is possible to shape the element by machining after the polymerisation of the resin, preferentially before the heat treatment (step (d)).

(iii) The strong chemical and physical affinity between the different constituents of the composite enables improved wetting of the α-SiC grains or inclusions by the β-SiC-based matrix. This is due to their similar chemical and physical natures in spite of their different crystallographic structure, i.e. α-SiC (hexagonal) and β-SiC (cubic). These similarities are essentially due to the specificity of the Si—C chemical bond which governs most mechanical and thermal properties and the high resistance to corrosive agents. They also enable the creation of strong bonds between the two phases (β-SiC matrix and inclusions) preventing rejection or detachment problems during use under stress. In addition, the α-SiC inclusions have a heat expansion coefficient very similar to that of the β-SiC matrix, making it possible to prevent the formation of residual stress liable to appear within the composite during the heat treatment or during cooling; this prevents the formation of cracks which could be detrimental for the finished element particularly in the event of its use in aluminium smelting furnaces or in fused salt electrolytic cells, and which may be difficult to detect on the finished element.

(iv) The applicant has observed that the composite material described has an extremely high resistance to corrosive environments, particularly fluorinated environments, concentrated acids or alkaline environments. This is probably due to the absence of binders with a lower resistance to said corrosive environments. Therefore, the elements manufactured in this material or composite enable improved operating savings. More specifically, in a given aggressive environment, the service life of the composite material elements is longer than that of SiC-based elements using binders with a relatively low resistance to these aggressive environments. This also improves the operating safety of the SiC elements, particularly their tightness, and opens up other applications impossible to envisage with Si-based materials wherein the binders are not chemically inert.

(v) By varying the chemical and physical nature of the inclusions, the method described can also be used to prepare other types of composite not only containing silicon carbide but also other materials such as alumina, silica or any other compounds, provided that they can be dispersed in resin and that they are not altered during synthesis. Adding these inclusions other than α-SiC, in a variable proportion, makes it possible to modify the mechanical and thermal properties of the final composite, i.e. improvement in heat transfer, oxidation resistance or clogging of pores. In this way, the material can be adapted to the specific requirements of the envisaged use.

(vi) By varying the proportion of the inclusions, particularly the mass percentage of α-SiC, it is possible to vary the thermal and mechanical resistance of the material, according to the target application.

The applicant has found that this SiC-based material containing inclusions, wherein at least part consists of α-SiC, in a β-SiC matrix, can be used, particularly in the form of refractory panels or bricks, as a coating material in various applications relating to thermal engineering, chemical engineering and/or electro-metallurgical engineering subject to high mechanical and thermal stress, and/or in the presence of corrosive liquids or gases. It may particularly be used in constituent parts of heat exchangers, burners, furnaces, reactors, or heating resistors, particularly in oxidising environments at moderate or high temperatures, or in installations in contact with corrosive chemical agents. It may also be used as a constituent in some elements used in the fields of aeronautical or space and land transport technology. It may also be used as a material used in the production of equipment used as a crucible support for high-temperature applications such as monocrystalline silicon rod synthesis. The material may be used as an inner coating for furnaces, such as aluminium smelting furnaces, and as a lining for fused salt electrolytic cells, e.g. for the production of aluminium by means of electrolysis using a mixture of alumina and cryolite. It may also be used as a constituent of a heat shield in a spaceship.

Another use of these materials is that as a lining (inner coating) for incineration furnaces, such as household waste incineration furnaces. During incineration, corrosive gases (HF, HCl, Cl₂, NO, NO₂, SO₂, SO₃, etc.) may be formed; these gases may attack the inner coating of the furnace.

The density of the material described is preferentially greater than 2.4 g/cm³. For the specified uses, a density between 2.45 and 2.75 g/cm³ is particularly suitable.

### EXAMPLES

### Example 1

### Production of β-SiC Panels Without Inclusions

1500 g of silicon powder (grain size focused on 7 μm), 560 g of carbon black (grain size focused on 20 nm) and 1000 g of phenolic resin are mixed in a mixer.

The paste obtained in this way is then compressed between two flat surfaces to obtain a 3 mm thick panel. This panel is hardened by heating at 200° C. for 3 hours. During this step, a weight loss corresponding to approximately 10% of the initial weight of the mixture is observed. The element obtained is easy to handle and has a smooth surface appearance.

Said element is then subject to progressive heating under a flow of argon at atmospheric pressure up to 1360° C., and it is then kept at this temperature for one hour. The element is then allowed to cool to ambient temperature. During this step, a weight loss corresponding to approximately 13.5% of the hardened element is observed. The appearance of the material is black as it still contains 7% free carbon.

This carbon is then eliminated by heating in air at 700° C. for 3 hrs. The panel then has a grey colour characteristic of pure β-SiC. The density of this panel was 1.2 g/cm³. It did not show any cracks.

Using a very similar method, β-SiC refractory bricks were produced with a smaller size greater than or equal to 15 cm, with no cracks.

### Example 2

### Production of β-SiC Panels with α-SiC Inclusion (α-SiC/β-SiC Composite)

### Alternative Embodiment (a)

4.5 g of silicon powder (average particle diameter: approximately 7 μm) is mixed with 5.5 g of a phenolic resin providing the source of carbon required for the carburisation to form the β-SiC intended to act as a binder in the final composite. 7 g of α-SiC in powder form is added to this mixture as a source of inclusions. The mixture was shaped by means of moulding.

The whole is polymerised in air at 150° C. for 2 hrs. The weight loss during this polymerisation was 2 grams. The solid obtained in this way is subjected to a heat treatment in a dynamic vacuum at 1300° C. with a temperature rise slope of 5° C. min⁻¹. During the temperature rise, the polymerised resin is carbonised and results, at high temperatures, in a carbon network in close contact with the silicon grains, facilitating SiC synthesis. The composite is kept at this temperature for 2 hrs so as to convert the carbon mixture obtained from the carbonised resin and the silicon into β-SiC. The composite obtained is then cooled with the natural thermal inertia of the furnace to ambient temperature. The weight loss during this heat treatment step was 1 gram.

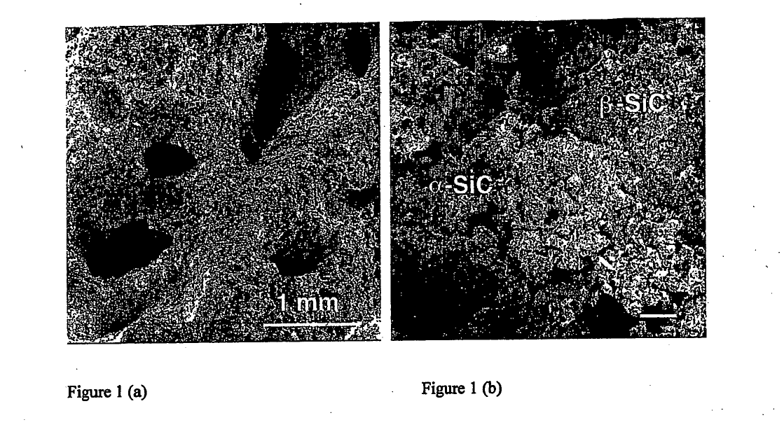

The product obtained in this way consists of a mixture of 50% α-SiC and 50% β-SiC wherein the α-SiC aggregates are dispersed homogeneously in a β-SiC-based matrix. It has physicochemical properties close or similar to those of composites based on α-SiC aggregates dispersed in an alumina and Si₃N₄ matrix. The scanning electron microscope images obtained of the composite after polymerisation and after carburisation are given in FIG. 1. The low-resolution image (FIG. 1A) clearly shows homogeneous dispersion of the α-SiC grains through the matrix consisting of β-SiC generated by the reaction at 1300° C. between the carbon in the resin and silicon.

The presence of a residual porosity is also observed in the final composite. This residual porosity is probably due to the contractions taking place in the resin core during the polymerisation step. This residual porosity may be removed by adjusting the heating slope during the polymerisation step or by using a different resin. The wetting between the two phases can be seen more clearly in the microscope image with a higher magnification factor given in FIG. 1B. This wetting is explained by the very similar physicochemical properties of both materials which inhibit rejection problems during the heat treatment as was the case with other binders which did not have the same heat expansion coefficient as the silicon carbide to be protected.

The way of preparing of composites makes it possible to vary the mass percentage of initial α-SiC within a broad range, in order to adapt the properties of the composite, such as its mechanical resistance and its porosity, to the target applications.

### Alternative Embodiment (b)

In other alternative embodiment, a mixture of 4.5 g of silicon powder, 5.5 g of phenolic resin and 73 g of α-SiC grains is produced. The mixture is shaped by means of pressing such that the resin and the silicon powder fill most of the free volume between the α-SiC grains.

The same procedure as for example 2(a) is then followed.

The product obtained then consists of a mixture of 91% α-SiC bound with 9% β-SiC and has a density of 2.5 g/cm³ with an open porosity of less than 20%.

### Example 3

### Use of β-SiC/α-SiC Composite Panels in a Corrosive Environment

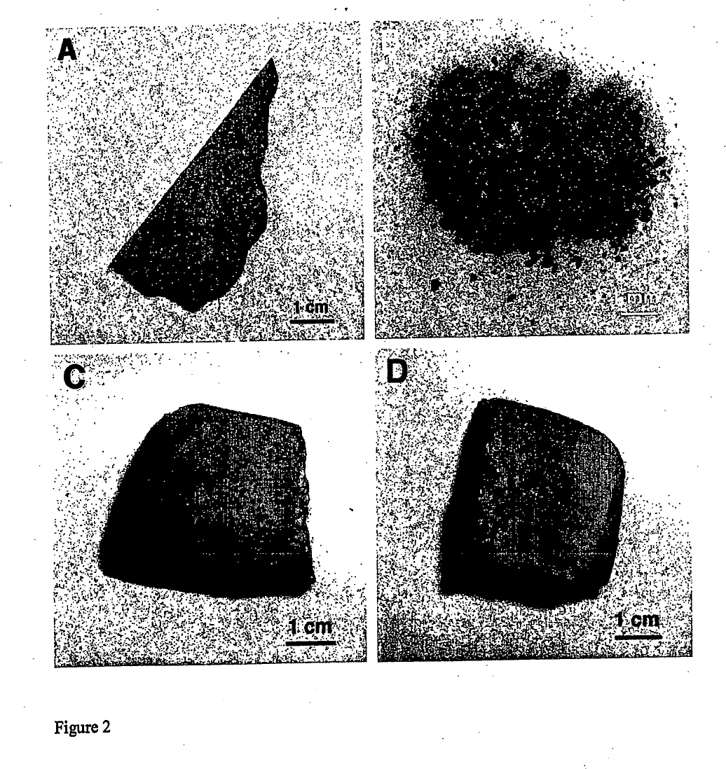

This example gives a clearer idea of the extreme resistance of the β-SiC-based composite material with inclusions (see example 2) compared to an α-SiC-based composite with oxide and/or nitride-based binders. A 40% by volume HF solution was used as a corrosive environment for this purpose. It is known that vapours or liquids containing hydrofluoric acid are extremely corrosive for ceramic oxide-based binders, causing severe matrix destruction problems. The results are given in FIG. 2.

The α-SiC/oxide and/or nitride-based binder composite (FIG. 2A) is completely destroyed after the treatment in HF solution inducing the complete destruction of the matrix and only the initial α-SiC powder is retrieved (FIG. 2B). The α-SiC/β-SiC composite prepared according to example 2 (alternative embodiment (a)) remains stable, and no obvious modification was detected after the treatment in HF (FIGS. 2C and D). This illustrates the chemical inertia of the β-SiC-based matrix with respect to the HF solution.

Using similar tests, the applicant observed that the β-SiC-based composite with inclusions also withstands treatments in basic environments such hot concentrated soda. The α-SiC/oxide and/or nitride-based binder-based composite is destroyed after a similar treatment, as the concentrated soda dissolves the binders.

This test was repeated with the material obtained from alternative embodiment (b) in example 2. The resistance to HF was excellent.

1. A SiC-based composite material capable of use as an inner coating for an aluminium smelting furnace or as an inner coating for a fused salt electrolytic cell, wherein said composite material has been prepared from a precursor mixture comprising at least one β-SiC precursor and at least one carbonated resin, and wherein said composite material contains inclusions, and wherein at least one part thereof of comprises α-SiC, in a β-SiC matrix.

2. A composite material according to claim 1, wherein a fraction by weight of said inclusions is between 80% and 95% with respect to the total mass of the precursor mixture.

3. A composite according to claim 1, wherein at least a portion of said inclusions comprise at least one of alumina, silica, TiN, and/or Si₃N₄.

4. A composite according to claim 1, wherein at least 50% by weight of said inclusions comprise α-SiC.

5. A composite according to claim 1, wherein said material has a density of at least 2.4 g/cm³.

6. A composite according to claim 1, wherein said material is in the form of bricks or panels.

7. A composite according to claim 1 capable of use as a lining for an electrolytic cell for the production of aluminium from a mixture of alumina and cryolite.

8. A composite according to claim 4, wherein at least 70% by weight of said inclusions comprise α-SiC.

9. A composite according to claim 5, wherein said density is from 2.45 to 2.75 g/cm³.

10. A composite according to claim 2, wherein at least a portion of said inclusions comprises at least one of alumina, silica, TiN, and/or Si₃N₄.

11. A composite according to claim 3, wherein at least 50% by weight of said inclusions comprise α-SiC.

12. A composite according to claim 4, wherein said material has a density of at least 2.4 g/cm³.

13. A composite according to claim 5, wherein said material is in the form of bricks or panels.

14. A composite according to claim 9, wherein said material is in the form of bricks or panels.

15. A coating for an aluminum smelting furnace comprising a composite of claim 1.

16. A coating for a fused salt electrolytic cell comprising a composite of claim 1.

17. A lining for an electrolytic cell comprising a composite of claim 1.

18. A method for making a coating suitable for use in an aluminum smelting furnace or an electrolytic cell comprising:
preparing a composite material from a precursor mixture comprising at least one β-SiC precursor and wherein said composite material comprises inclusions, and further wherein at least a portion thereof comprises α-Si—C in a β-Si—C matrix, and
forming said coating from said composite material.

19. A method of claim 18, wherein at least a portion of said inclusions comprise at least one of alumina, silica, TiN, and/or Si₃N₄.

20. A coating prepared by a method of claim 18.
